(19) United States
(12) Patent Application Publication
(10) Pub. No.: US 2023/0269672 A1
(43) Pub. Date: Aug. 24, 2023

(54) SELF-ADAPTIVE TRANSMIT POWER CONTROL FOR BLUETOOTH

(71) Applicant: QUALCOMM Incorporated, San Diego, CA (US)

(72) Inventors: Pei WANG, Shanghai (CN); Liang HE, Shanghai (CN); Wei XIA, Shanghai (CN); Joel LINSKY, San Diego, CA (US)

(21) Appl. No.: 18/000,445

(22) PCT Filed: Jul. 16, 2020
(86) PCT No.: PCT/CN2020/102357

§ 371 Date: Dec. 1, 2022

(51) Int. Cl. H04W 52/24; H04W 52/52

(52) U.S. Cl. CPC H04W 52/245; H04W 52/52

(57) ABSTRACT

Disclosed are techniques for wireless communication. In an aspect, a controller wireless device establishes a wireless communication link with a remote wireless device according to a configuration profile for a wireless communications standard, receives, from the remote wireless device, a first request to increase a transmit power level of the controller wireless device, determines whether a signal strength metric for the wireless communication link is below a first signal strength threshold, whether a reliability metric for the wireless communication link is below a first reliability threshold, or both, and based on the signal strength metric being below the first signal strength threshold, the reliability metric being below the first reliability threshold, or both, increases the transmit power level of the controller wireless device.

### CROSS-REFERENCE TO RELATED APPLICATIONS

The present application for patent claims priority to International Patent Application No. PCT/CN2020/102357, entitled “SELF-ADAPTIVE TRANSMIT POWER CONTROL FOR BLUETOOTH,” filed Jul. 16, 2020, which is assigned to the assignee hereof and expressly incorporated herein by reference in its entirety.

### 1. FIELD OF THE DISCLOSURE

Aspects of this disclosure relate generally to wireless communications and the like.

### 2. DESCRIPTION OF THE RELATED ART

Bluetooth® is a wireless technology for establishing packet-based wireless networks among wireless devices operating in the 2.402 GHz to 2.480 GHz frequency range. Low power wireless devices compliant with the Bluetooth® specification are found in applications in healthcare, fitness, security, home appliances, and home entertainment, to name a few examples. There are different Bluetooth® specifications, including Bluetooth® Low Energy (BLE) and Classic Bluetooth®. BLE devices are marketed as Bluetooth® Smart devices, and are expected to run for long periods of time, perhaps years, on a button or coin battery. Bluetooth® Smart Ready devices are wireless devices with dual protocol stacks capable of communicating with legacy Classic Bluetooth® devices as well as Bluetooth® Smart devices. For example, a cellphone may have Bluetooth® Smart Ready capability so that it may communicate with a legacy Classic Bluetooth® headset as well as a personal device having Bluetooth® Smart capability.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a controller wireless device includes establishing a wireless communication link with a remote wireless device according to a configuration profile for a wireless communications standard, receiving, from the remote wireless device, a first request to increase a transmit power level of the controller wireless device, determining whether a signal strength metric for the wireless communication link is below a first signal strength threshold, whether a reliability metric for the wireless communication link is below a first reliability threshold, or both, and, based on the signal strength metric being below the first signal strength threshold, the reliability metric being below the first reliability threshold, or both, increasing the transmit power level of the controller wireless device.

In an aspect, a controller wireless device includes a memory, a wireless interface, and at least one processor communicatively coupled to the memory and the wireless interface, the at least one processor configured to: establish a wireless communication link with a remote wireless device according to a configuration profile for a wireless communications standard, receive, from the remote wireless device, a first request to increase a transmit power level of the controller wireless device, determine whether a signal strength metric for the wireless communication link is below a first signal strength threshold, whether a reliability metric for the wireless communication link is below a first reliability threshold, or both, and increase the transmit power level of the controller wireless device based on the signal strength metric being below the first signal strength threshold, the reliability metric being below the first reliability threshold, or both.

In an aspect, a controller wireless device includes means for establishing a wireless communication link with a remote wireless device according to a configuration profile for a wireless communications standard, means for receiving, from the remote wireless device, a first request to increase a transmit power level of the controller wireless device, means for determining whether a signal strength metric for the wireless communication link is below a first signal strength threshold, whether a reliability metric for the wireless communication link is below a first reliability threshold, or both, and means for increasing the transmit power level of the controller wireless device based on the signal strength metric being below the first signal strength threshold, the reliability metric being below the first reliability threshold, or both.

In an aspect, a non-transitory computer-readable medium storing computer-executable instructions includes computer-executable instructions comprising: at least one instruction instructing a controller wireless device to establish a wireless communication link with a remote wireless device according to a configuration profile for a wireless communications standard, at least one instruction instructing the controller wireless device to receive, from the remote wireless device, a first request to increase a transmit power level of the controller wireless device, at least one instruction instructing the controller wireless device to determine whether a signal strength metric for the wireless communication link is below a first signal strength threshold, whether a reliability metric for the wireless communication link is below a first reliability threshold, or both, and at least one instruction instructing the controller wireless device to increase the transmit power level of the controller wireless device based on the signal strength metric being below the first signal strength threshold, the reliability metric being below the first reliability threshold, or both.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates various consumer devices in which aspects of the disclosure may be incorporated.

FIG. 2 illustrates a simplified diagram of an exemplary architecture of a device capable of implementing the techniques described herein.

FIG. 3 is a diagram of different scenarios in which a controller device may increase its transmit power, according to aspects of the disclosure.

FIGS. 4A and 4B illustrate an exemplary method for implementing self-adaptive power control, according to aspects of the disclosure.

FIG. 5 illustrates an exemplary method for wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term Bluetooth® (BT) device refers to any type of device that includes Bluetooth® capability, whether Bluetooth® Classic, Bluetooth® Smart, Bluetooth® Smart Ready, or other. In general, a BT device may be any wireless communication device, such as a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc., used by a user to communicate with another BT device over a Bluetooth® link. In addition to being Bluetooth® capable, a BT device may be able to communicate over other types of wireless networks, such as a wireless local area network (WLAN) (e.g., based on IEEE 802.11, etc.) or a cellular network (e.g., Long-Term Evolution (LTE), 5G New Radio, etc.), to name a few examples. Such a BT device may be referred to interchangeably as a “user equipment” (UE), an “access terminal” (AT), a “client device,” a “wireless device,” a “subscriber device,” a “subscriber terminal,” a “subscriber station,” a “user terminal” (UT), a “mobile device,” a “mobile terminal,” a “mobile station,” or variations thereof.

A BT device may be configured as a controller (or “master”) or remote (or “slave” or “peripheral”). Often the controller is a smartphone, tablet, or personal computer. A master may set up a wireless network with multiple remotes, where connections are established between the master and each remote. A BT device may also be configured as a server or a client. In practice, the server may be thought of as having data of interest, whereas a client connects with the server to request the data and perhaps modify the state of the server. Usually, the controller is the client and a remote is the server.

For example, a Bluetooth® home thermostat may store temperature values over some period of time and perform as a server and remote to a smartphone when the smartphone is brought in proximity to the home thermostat. The home thermostat may advertise itself so that when the smartphone is in range a connection is established with the smartphone as the controller and the home thermostat as the remote. In this example, the smartphone performs as the client, requesting the stored temperature values from the home thermostat. Based upon an application running on the smartphone, the smartphone may change the state of the thermostat whereby the home thermostat's temperature setting is raised or lowered depending upon the stored temperature readings and other information that the smartphone may access from the home thermostat or perhaps from cloud-based databases.

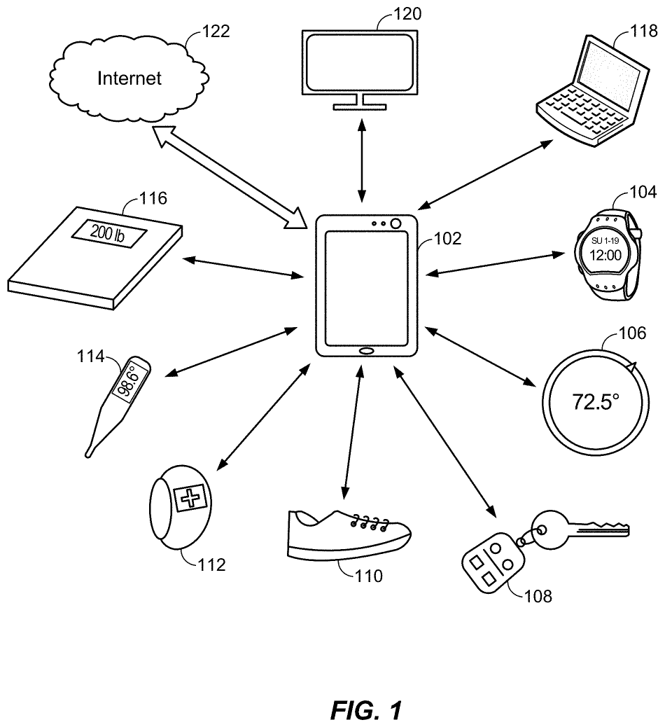

Bluetooth® technology has found applications in many devices in common use around the home, office, factory, etc. For example, FIG. 1 illustrates a wireless network in which a smartphone 102 may be a master and client to multiple Bluetooth® capable devices: a wristwatch 104 with a sensor to measure pulse rate; a home thermostat 106; a key fob 108 with stored car seat settings and other car preferences; an athletic shoe 110 with a pedometer; a wrist band 112 with a sensor to measure blood pressure and heart rate; a personal thermometer 114; a weight scale 116; a laptop 118; and a television 120. The smartphone 102 may be connected to the Internet 122 so that various databases may be accessed to store readings or to adjust the state of some of the BT devices, or perhaps to alert a health care professional or emergency service personnel if a reading from a BT device indicates a health issue or urgent situation.

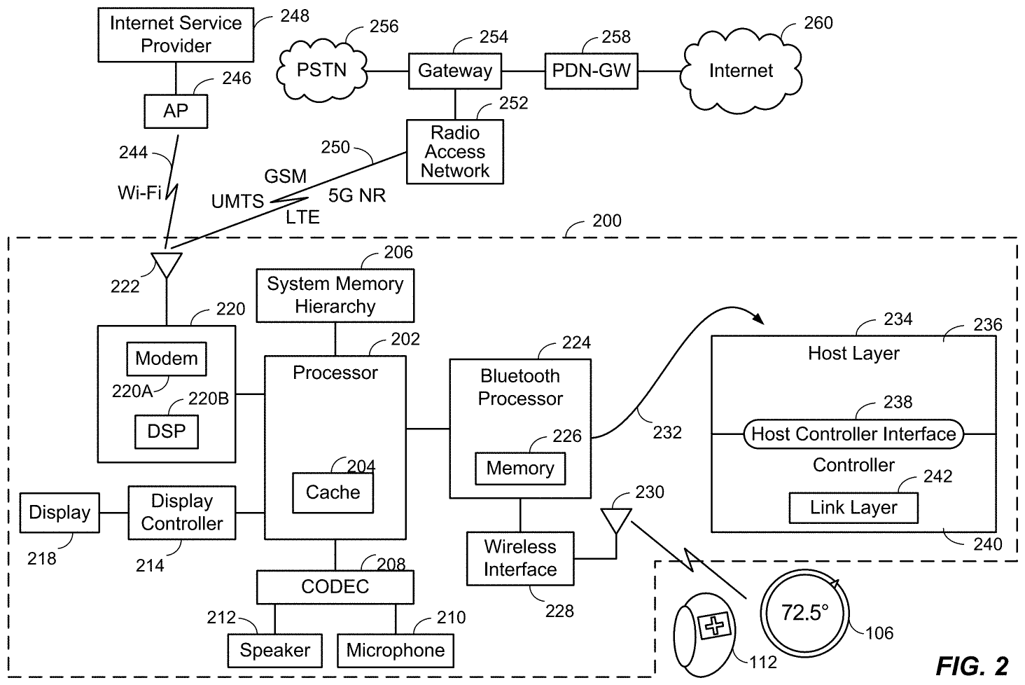

FIG. 2 illustrates a BT device 200 in which aspects of the disclosure may find application. The BT device 200 may be any one of a number of communication devices, such as a smartphone, tablet, or laptop, to name a few examples. The BT device 200 may be a controller BT device or a peripheral BT device, or may at times operate as a controller BT device or a peripheral BT device. The main processor 202 for the BT device runs applications visible to the user of the BT device and includes a cache memory 204 as well as an interface to store and retrieve data and instructions from off-chip memory, represented in FIG. 2 as the system memory hierarchy 206. The system memory hierarchy 206 may comprise various volatile and non-volatile memory systems. Also shown in FIG. 2 is the CODEC (coder-decoder) 208 for interfacing with the microphone 210 and the speaker 212. The display controller 214 provides an interface to the display 218 so that the user may easily interact with the BT device.

The BT device is capable of interfacing with other wireless networks by way of a transceiver 220, also referred to as a wireless interface, and one or more antennas 222. The transceiver 220 is illustrated as comprising a modem 220A and a digital signal processor (DSP) 220B, although in practice other kinds of modules may be employed, all or some such modules may be integrated on a single chip, and some of the modules may be integrated with the processor 202.

The main processor 202 may implement a Bluetooth® Classic, Bluetooth® Smart, and/or Bluetooth® Smart Ready protocol stack in which instructions for performing some or all of the protocol stack are stored in the system memory hierarchy 206. However, in the example of FIG. 2, a separate chip or an embedded hardware core, shown as a Bluetooth® processor 224, implements the portions of the protocol stack to perform the Bluetooth® functionality described herein. The Bluetooth® processor 224 comprises a memory 226, shown as an on-chip memory, although the memory 226 may be part of a memory hierarchy in which some memory also resides off-chip. A wireless interface 228 provides an interface to one or more antennas 230, suitable for operating in the designated frequency spectrum utilized by Bluetooth®. Communication may be made any number of Bluetooth® capable devices, such as for example the home thermostat 106 or the wristband 112, to name just two examples.

The arrow 232 serves to indicate that the Bluetooth® processor 224 performs the protocol stack, represented by the box labeled 234. Shown in the protocol stack 234 are the host layer 236, the host controller interface 238, and the controller 240. The controller 240 includes the link layer 242. For ease of illustration, not all layers are shown. Software or firmware running on the Bluetooth® processor 224 may implement all or some of the layers in the protocol stack 234, and special purpose hardware, such as an ASIC, may also implement some of the layers.

It is to be appreciated that the Bluetooth® processor 224 may represent more than one processor, where for example a programmable processor may implement the host layer 236 and a DSP may implement some or all of the actions performed by controller 240, except perhaps for the physical layer (not shown). The instructions for implementing some or all of the Bluetooth® functionality described herein may be stored in a memory, such as for example the memory 226. The memory 226 may be referred to as a non-transitory computer readable medium.

The BT device 200 can participate in one or more wireless networks to gain access to the Internet. In the example of FIG. 2, the BT device 200 has a Wi-Fi link 244 to an access point (AP) 246, where an Internet service provider (ISP) 248 provides access to the Internet.

The BT device 200 may also have the functionality of a cellular phone so as to participate in any one of a number of cellular networks. For example, the BT device 200 may have an air interface link 250 that may, for example, be compatible with various cellular networks, such as Global System for Mobile communications (GSM), Universal Mobile Telecommunications Systems (UMTS), Long-Term Evolution (LTE), 5G New Radio (NR), and the like. The air interface link 250 provides communication to a radio access network 252, where the architecture of the radio access network 252 depends upon the type of cellular network standard. For example, in the case of GSM, the radio access network 252 may include a base station, for UMTS it may include a Node-B, for LTE it may include an eNode-B, and for 5G NR it may include a gNode-B, as specified by 3GPP (3rd Generation Partnership Project).

Not all functional units are illustrated in FIG. 2 for providing a connection to the Internet, but for ease of illustration several components are shown, such as the gateway 254 that generically represents several network components for providing communication to the public switched telephone network (PSTN) 256 and the packet data network gateway (PDN-GW) 258, where the PDN-GW 258 provides the proper communication interface to the Internet 260. As is apparent, the network architecture illustrated in FIG. 2 for the Wi-Fi link 244 and the air interface link 250 is simplified for ease of illustration.

Under the current Bluetooth® specification, a BT device may use an unnecessarily high transmit power level when communicating with other BT devices according to certain Bluetooth® profiles. Bluetooth® profiles are definitions of possible applications and specify general behaviors that BT devices use to communicate with other BT devices. These profiles include settings to parameterize and to control communication between the BT devices from the start of the communication session. Using profiles saves the time of having to transmit the parameters before the communication link becomes effective.

There are a wide range of Bluetooth® profiles that describe many different types of applications or use cases for BT devices. Some of these profiles have been reported to consume excessive power, especially when the involved BT devices are close to each other. These profiles include the Advanced Audio Distribution Profile (A2DP), Hands-Free, and Object Push Profile (OPP) profiles. The A2DP profile defines how multimedia audio can be streamed from one BT device to another (also referred to as Bluetooth® Audio Streaming). For example, audio can be streamed from a mobile phone or laptop to a wireless headset. The Hands-Free profile is used to allow vehicle hands-free kits to communicate with mobile phones in the vehicle. The A2DP profile can be used to implement the Hands-Free profile, or both profiles can be used separately. The OPP profile is a basic profile for sending “objects,” such as pictures, virtual business cards, or appointment details. It is referred to as a “push” profile because the transfers are initiated by the sender, not the receiver.

A Bluetooth® communication link established according to a particular Bluetooth® profile can be referred to as a link of that profile. For example, a communication link established according to the A2DP profile can be referred to as an A2DP link.

The above profiles have been identified as using excessing power. For example, the power consumption of a current generation Bluetooth® chipset when operating according to these profiles is approximately 40 milliamps (mA) to 80 mA higher than that of previous generation Bluetooth® chipsets.

The reason for the high-power consumption in these use cases is the following. After setup of the Bluetooth® link, the controller BT device uses an initial transmit power level to send packets to the remote BT device. The remote BT device can send increase or decrease power requests to change the controller BT device's transmit power level. Over short distances, such as less than one meter, many remote BT devices will request the controller BT device to use a higher transmit power level, and in some cases, the maximum transmit power level. For a current generation Bluetooth® chipset, using a 14-nm manufacturing process and a lower chip voltage than earlier generation Bluetooth® chipsets, the internal power amplifier (iPA), located, for example, in the Bluetooth® processor 224, may not be able to provide enough transmit power to meet the requests of the remote BT device. Under this condition, the external power amplifier (xPA), located, for example, in the wireless interface 228 or the modem 220A, is used to achieve the requested transmit power level. However, power consumption using the xPA is much higher than that of the iPA.

Table 1 provides exemplary power values for a Bluetooth® OPP use case when a controller BT device is transmitting a file. In the example of Table 1, the controller BT device is equipped with a Bluetooth® chipset that uses an xPA to improve transmit power. As can be seen in Table 1, when the controller BT device is transmitting at greater than PowerlLevel_1, the xPA contributes the most to the power consumption. As such, a remote BT device requesting the controller BT device to use a higher transmit power in combination with the controller BT device using its xPA at higher transmit power levels, results in high power consumption.

TABLE 1

| | Total | iPA | xPA | | |
|---|---|---|---|---|---|
| | Current | Current | Current | GFSK | EDR |
| | (mA) | (mA) | (mA) | (dBm) | (dBm) |
| PowerLevel_0 | 84 | 36 | 0 | 4 | 2 |
| PowerLevel_1 | 92 | 44 | 0 | 9 | 7 |
| PowerLevel_2 | 175 | 20 | 106 | 14 | 12 |
| PowerLevel_3 | 211 | 22 | 140 | 19 | 17 |

Note that “GFSK” stands for “gaussian frequency shift keying” and “EDR” stands for “enhanced data rate.”

According to the current Bluetooth® Core specification, if the received signal characteristics differ too much from the preferred value of a BT device, the BT device may request an increase or a decrease of the other BT device's transmit power level. This means that when both BT devices connected over a Bluetooth® link support power control, transmit power is controlled by the remote BT device.

For near distances (even less than one meter), PowerLevel_0 or PowerLevel_1 is usually sufficient to meet the quality requirement(s) of the traffic transmitted over the link. However, many remote BT devices will request the controller BT device to increase to PowerLevel_2 or PowerLevel_3 to transmit packets over the link, which results in the controller BT device consuming additional transmit power unnecessarily.

Accordingly, the present disclosure provides techniques for self-adaptive transmit power control by which a controller BT device can control its transmit power level by itself as well as by request from a remote BT device. The present disclosure makes the following assumptions. First, for a BT device with power control enabled, using the xPA consumes more power than using the iPA. Second, the BT devices are operating according to a BT profile, such as an A2DP, OPP, or Hands-Free profile. When the BT devices disconnect from the profile, their transmit power levels will reset if necessary. Third, the controller BT device's current transmit power is assumed to have already reached PowerLevel_1. Specifically, the self-adaptive power control techniques described herein can be used to adjust the power index for levels greater than or equal to PowerLevel_1. For PowerLevel_0 and lower power levels, power consumption is low, and the power control logic in the current Bluetooth® specification can be followed.

When operating according to the techniques of the present disclosure, a BT controller device (more specifically, the Bluetooth® Controller software running on the BT controller device) can control the transmit power level dynamically while the Bluetooth® link, such as an A2DP, OPP, or Hands-Free link, is setup. Once PowerLevel_1 is reached, the controller BT device switches to the self-adaptive power control mode described herein. If the remote BT device requests the controller BT device to increase its transmit power level higher than PowerLevel_1, the controller BT device can instead adjust its transmit power based on the signal strength and reliability of the link, instead of the power control logic in the current Bluetooth® specification. The signal strength of the link may be determined from the received signal strength indication (RSSI) or other signal strength metric of the link. The reliability of the link may be determined by the retransmission rate (based on the remote BT device's non-acknowledge rate (NackRate)) or other reliability metric of the link. When operating in the self-adaptive power control mode, the BT device may periodically (e.g., every one second) determine whether or not to adjust its transmit power up or down one power level at a time.

To track the NackRate of the Bluetooth® link, the controller BT device can record the number of packets transmitted over some period of time (e.g., one second) and the number of negative acknowledgements (NACKs) over the same period of time. The controller BT device can then calculate the NackRate as the ratio of the number of NACKs to the number of packets transmitted. Alternatively, the controller BT device can record the number of positive acknowledgments (ACKs) and the number of NACKs over some period of time (e.g., one second). The controller BT device can then calculate the NackRate as the ratio of the number of NACKs to the number of ACKs.

In an aspect, the controller BT device can increase its transmit power according to the following rules. If the NackRate (or other link reliability metric) is greater than a threshold (e.g., ⅓), the controller BT device can increase its transmit power from PowerLevel_1 to PowerLevel_2 or from PowerLevel_2 to PowerLevel_3, as appropriate. If the RSSI (or other signal strength metric) of the link is less than a first threshold (e.g., −72 dBm), the controller BT device can increase its transmit power from PowerLevel_1 to PowerLevel_2. If the RSSI of the link is les than a second threshold (e.g., −77 dBm), the controller BT device can increase its transmit power from PowerLevel_1 to PowerLevel_2 or from PowerLevel_2 to PowerLevel_3, as appropriate. As will be appreciated, these rules and values are exemplary, and the disclosure is not limited to these examples.

When the RSSI of the link is lower than a threshold, it likely means the controller BT device is relatively far away from the remote BT device. However, environment interference can also affect the RSSI and the NackRate. If that is the case, increasing the transmit power will help to ensure link transmit quality.

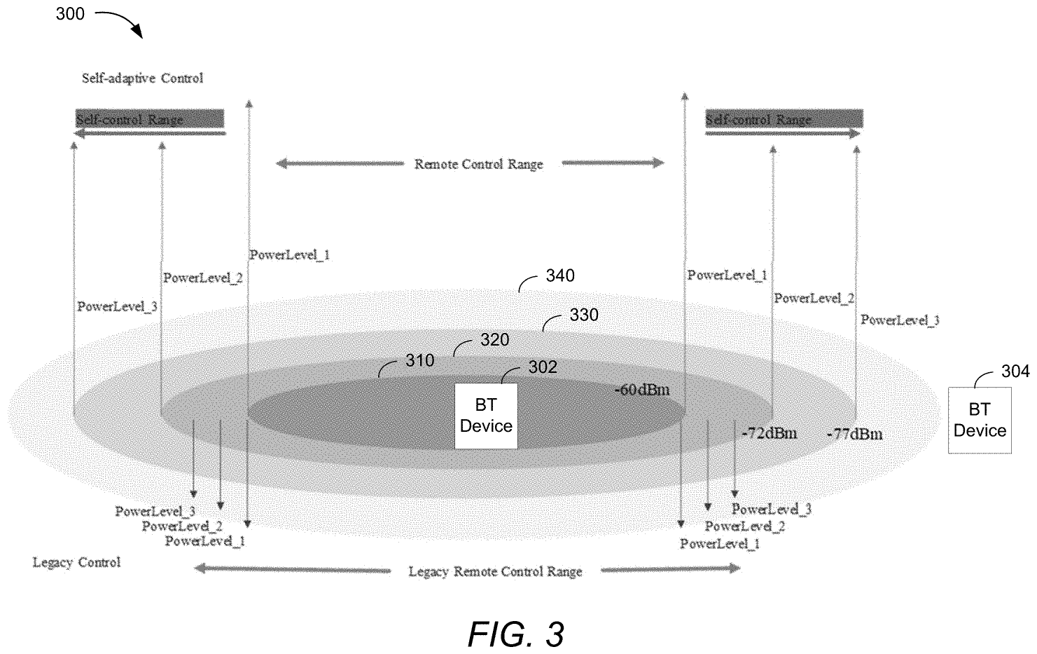

FIG. 3 is a diagram 300 of different scenarios in which a controller BT device may increase its transmit power, according to aspects of the disclosure. In FIG. 3, a controller BT device 302 has established a Bluetooth® link with a remote BT device 304. The Bluetooth® link may be established and operate according to a Bluetooth® profile, such as the A2DP profile, the OPP profile, the Hands-Free profile, etc. Within range 310, where the RSSI of the link is less than, for example, −60 dBm, the remote BT device 304 controls the transmit power of the controller BT device 302 according to the currently specified power control logic. This range is labeled the “Remote Control Range.” Within this range, the controller BT device 302 may increase its transmit power level up to PowerLevel_1 at the request of the remote BT device 304.

Beyond range 310, the controller BT device 302 transmits at PowerLevel_1 or higher and switches to the self-adaptive power control mode described herein. In the example of FIG. 3, there are three ranges beyond range 310, range 320, range 330, and range 340. These ranges are labeled the “Self-Control Range.” Within range 320, the RSSI of the link is greater than, for example, −60 dBm but less than, for example, −72 dBm, and the controller BT device 302 may operate at PowerLevel_1 (as illustrated by the upward pointing arrow). Within range 330, the RSSI of the link is greater than, for example, −72 dBm but less than, for example, −77 dBm, and the controller BT device 302 may operate at PowerLevel_2 (as illustrated by the upward pointing arrow). Within range 340, the RSSI of the link is greater than, for example, −77 dBm, and the controller BT device 302 may operate at PowerLevel_3 (as illustrated by the upward pointing arrow). As will be appreciated, the thresholds of −60 dBm, −72 dBm, and −77 dBm are merely exemplary, and the disclosure is not limited to these examples.

In addition to the self-adaptive power control mode, FIG. 3 also illustrates the legacy power control behavior. As shown on the bottom of FIG. 3, all ranges, regardless of RSSI, would be subject to the current power control logic. This range is labeled the “Legacy Remote Control Range.” Within this range, the remote BT device 304 can quickly cause the controller BT device 302 to increase its transmit power to PowerLevel_3, as illustrated by the downward pointing arrows, even before the RSSI of the link reaches −72 dBm.

There may also be times when the controller BT device can decrease its transmit power. For example, if the controller BT device is already using the xPA to transmit over the link, the controller BT device can decrease its transmit power level dynamically to reduce power consumption.

In an aspect, the controller BT device can decrease its transmit power according to the following rules. If the RSSI is greater than a first threshold (e.g., −74 dBm) and the NackRate is less than a threshold (e.g., 1/10), the controller BT device can decrease its transmit power from PowerLevel_3 to PowerLevel_2. If the RSSI is less than the first threshold but greater than a second threshold (e.g., −69 dBm) and the NackRate is less than a threshold (e.g., 1/10), the controller BT device can decrease its transmit power from PowerLevel_3 to PowerLevel_2 or from PowerLevel_2 to PowerLevel_1, as appropriate. The controller BT device can also decrease its transmit power level if the RSSI and NackRate meet the conditions above.

Using the above rules for increasing and decreasing transmit power, the controller BT device can promote link quality while decreasing transmit power.

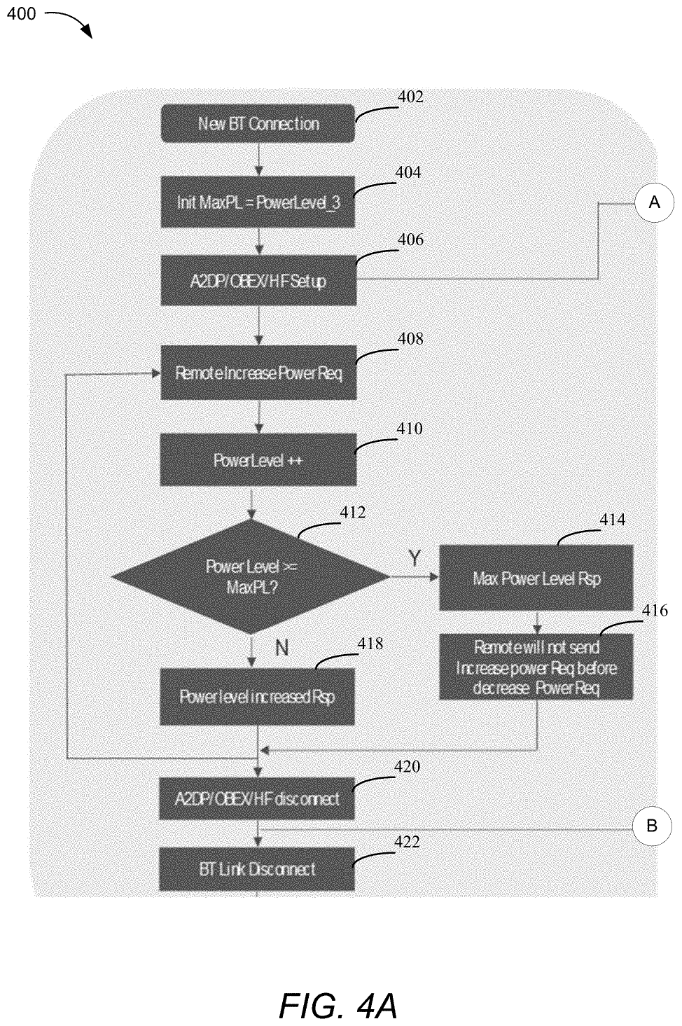

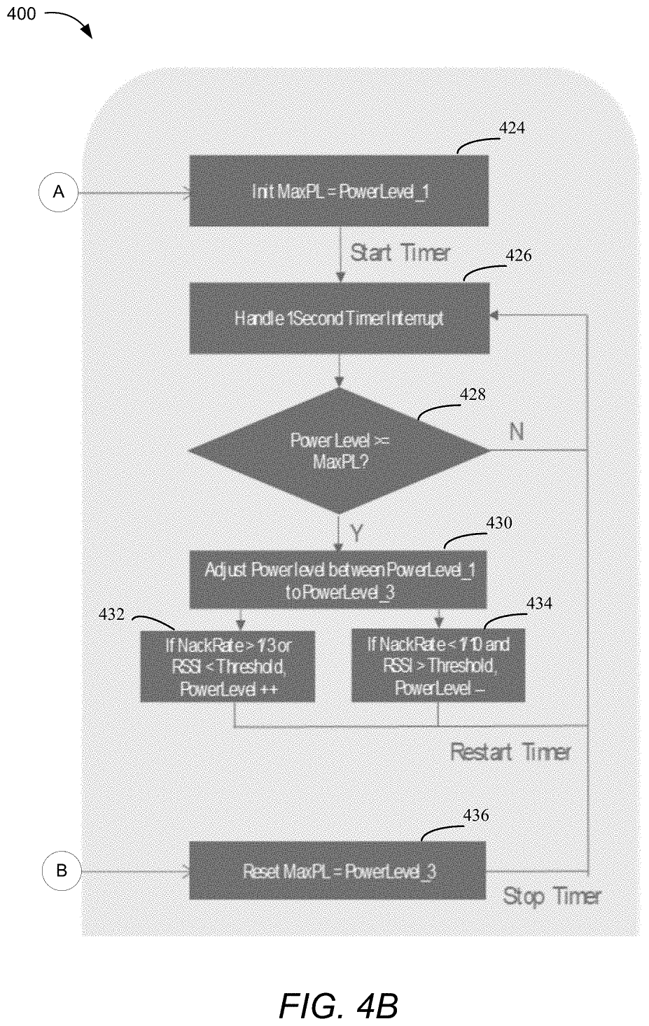

FIGS. 4A and 4B illustrate an exemplary method 400 for implementing self-adaptive power control, according to aspects of the disclosure. In an aspect, the method 400 may be performed by a controller BT device.

At 402, the controller BT device establishes a Bluetooth® connection, or link, with a remote BT device. At 404, the controller BT device sets its initial maximum power level (“MaxPL”) to PowerLevel_3. At 406, the controller BT device sets up an A2DP, OPP, or Hands-Free (HF) profile for the link. From block 406, operation splits to 408 and 424, as indicated by reference “A.” Blocks 406 to 422 of FIG. 4A run in parallel with, or at the same time as, blocks 424 to 436 in FIG. 4B. Block 422 terminates the portion of method 400 illustrated in FIG. 4B.

As illustrated in FIG. 4B, at 424, the controller BT device sets its initial maximum power level (“MaxPL”) to PowerLevel_1 and starts a timer, such as a one-second timer. At 426, the controller BT device handles an interrupt from the timer due to expiration of the timer. In response to the interrupt, at 428, the controller BT device determines whether the current transmit power level is greater than or equal to the maximum power level. If it is, then at 430, the controller BT device adjusts the power level between PowerLevel_1 and PowerLevel_3. Specifically, at 432, if the NackRate is greater than a first threshold (e.g., ⅓) or the RSSI of the link is less than a threshold (e.g., −72 dBm or −77 dBm), the controller BT device increments the transmit power level to the next higher power level. If, however, the NackRate is less than a second threshold (e.g., 1/10) and the RSSI of the link is greater than a threshold (e.g., −69 dBm or −74 dBm), the controller BT device decrements the transmit power level to the next lower power level. The controller BT device then restarts the (one-second) timer and returns to block 426.

If, at 428, the controller BT device determines that the current transmit power level is not greater than or equal to the maximum power level, then the controller BT device returns to 426. More specifically, when the power level is less than MaxPL (here, PowerLevel_1), the currently-defined power control logic is used, meaning that the iPA is used for transmission. As such, there is no need to adjust the power level.

Returning to FIG. 4A, at 408, the controller BT device receives a transmit power increase request from the remote BT device. At 410, the controller BT device increments the transmit power level to the next higher power level. At 412, the controller BT device determines whether the current transmit power level is greater than or equal to the maximum transmit power level. If it is, then at 414, the controller BT device sends a message to the remote BT device indicating that it cannot increase its transmit power. In response, the remote BT device will not send any further power increase requests before sending a decrease power request, as indicated by block 416.

If the current transmit power level is not greater than or equal to the maximum power level, then at 418, the controller BT device sends a message to the remote BT device indicating that it will increase the transmit power level. If the controller BT device receives another power increase request, the method 400 returns to 408, otherwise, at 420, the controller BT device disconnects the A2DP, OPP, or Hands-Free (HF) profile for the link. In addition, at 436, the controller BT device resets the maximum transmit power level to PoweLevel_3 and stops the (one-second) timer. The reason for resetting the maximum transmit power level is that when related profiles are disconnected, there is no need to apply the disclosed power control logic; rather, the controller BT device returns to the legacy power control (in which transmit power is controlled by the remote device). In addition, after the profiles disconnect, there are less packets to send, so even if the remote device requests maximum power (e.g., PowerLevel_3), it would not consume too much power. At 422, the link becomes idle and the controller BT device waits for a new profile connection or waits for link disconnection. In the event of a link disconnection, the controller BT device disconnects the Bluetooth® link to the remote BT device.

Note that while the foregoing has described transmit power levels up to PowerLevel_3, as will be appreciated, there may be more or fewer power levels. In addition, while the foregoing techniques have been described in terms of Bluetooth® communications, as will be appreciated, these power control techniques may apply to other device-to-device (D2D) and/or peer-to-peer (P2P) wireless communication technologies, such as WLAN, LTE Direct, Zigbee®, Adaptive Network Technology (ANT), etc.

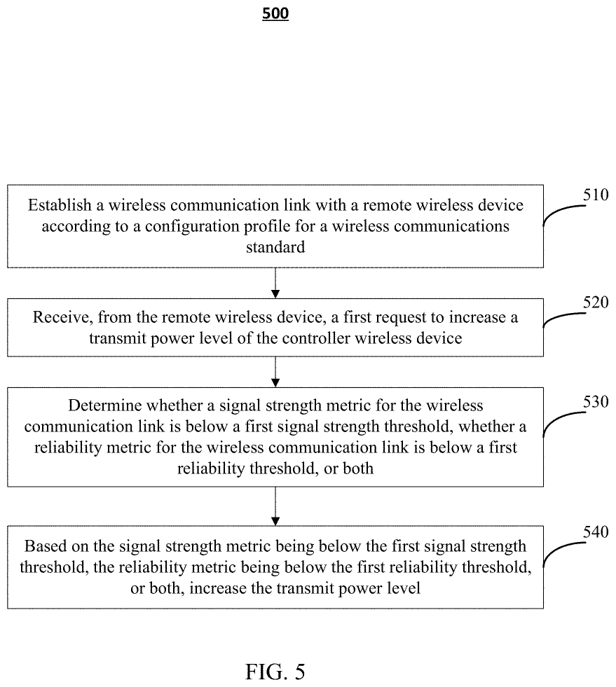

FIG. 5 illustrates an exemplary method 500 for wireless communication, according to aspects of the disclosure. In an aspect, the method 500 may be performed by a controller wireless device, such as a controller BT device.

At 510, the controller wireless device establishes a wireless communication link with a remote wireless device according to a configuration profile for a wireless communications standard. In an aspect, operation 510 may be performed by the Bluetooth® processor 224, the memory 226, and/or the wireless interface 228, any or all of which may be considered means for performing this operation.

At 520, the controller wireless device receives, from the remote wireless device, a first request to increase a transmit power level of the controller wireless device. In an aspect, operation 520 may be performed by the Bluetooth® processor 224, the memory 226, and/or the wireless interface 228, any or all of which may be considered means for performing this operation.

At 530, the controller wireless device determines whether a signal strength metric for the wireless communication link is below a first signal strength threshold, whether a reliability metric for the wireless communication link is below a first reliability threshold, or both. In an aspect, operation 530 may be performed by the Bluetooth® processor 224, the memory 226, and/or the wireless interface 228, any or all of which may be considered means for performing this operation.

At 540, the controller wireless device increases, based on the signal strength metric being below the first signal strength threshold, the reliability metric being below the first reliability threshold, or both, the transmit power level of the controller wireless device. In an aspect, operation 540 may be performed by the Bluetooth® processor 224, the memory 226, and/or the wireless interface 228, any or all of which may be considered means for performing this operation.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a controller wireless device, comprising:
establishing a wireless communication link with a remote wireless device according to a configuration profile for a wireless communications standard;
receiving, from the remote wireless device, a first request to increase a transmit power level of the controller wireless device;
determining whether a signal strength metric for the wireless communication link is below a first signal strength threshold, whether a reliability metric for the wireless communication link is below a first reliability threshold, or both; and
based on the signal strength metric being below the first signal strength threshold, the reliability metric being below the first reliability threshold, or both, increasing the transmit power level of the controller wireless device.

2. The method of claim 1, wherein the determining comprises:
determining whether the signal strength metric is below the first signal strength threshold, whether the reliability metric is below the first reliability threshold, or both based on a current transmit power level of the controller wireless device being greater than or equal to a power level threshold.

3. The method of claim 2, wherein, based on the current transmit power level of the controller wireless device being below the threshold, the wireless controller device increases the transmit power level of the controller wireless as requested by the remote wireless device.

4. The method of claim 2, wherein the power level threshold comprises a power level at which only an internal power amplifier (iPA) is used for transmitting over the wireless communication link.

5. The method of claim 2, wherein the power level threshold comprises a power level at which an external power amplifier (xPA) is used for transmitting over the wireless communication link.

6. The method of claim 1, further comprising:
determining whether the signal strength metric is above a second signal strength threshold, whether the reliability metric is above a second reliability threshold, or both; and
based on the signal strength metric being above the second signal strength threshold, the reliability metric being above the second reliability threshold, or both, decreasing the transmit power level of the controller wireless device.

7. The method of claim 6, wherein the decreasing comprises:
decreasing the transmit power level of the controller wireless device one transmit power level.

8. The method of claim 6, wherein the controller wireless device periodically determines whether the signal strength metric is above the second signal strength threshold, whether the reliability metric is above the second reliability threshold, or both.

9. The method of claim 6, wherein:
the second signal strength threshold is higher than the first signal strength threshold, and
the second reliability threshold is higher than the first reliability threshold.

10. The method of claim 1, wherein the increasing comprises:
increasing the transmit power level of the controller wireless device one transmit power level.

11. The method of claim 1, further comprising:
receiving, from the remote wireless device, a second request to increase the transmit power level of the controller wireless device;
determining whether the signal strength metric is below a second signal strength threshold and whether the reliability metric is below the first reliability threshold; and
based on the signal strength metric being below the second signal strength threshold and the reliability metric being below the first reliability threshold, increasing the transmit power level of the controller wireless device.

12. The method of claim 11, wherein the second signal strength threshold is lower than the first signal strength threshold.

13. The method of claim 1, further comprising:
receiving, from the remote wireless device, a second request to increase the transmit power level of the controller wireless device;
determining whether the signal strength metric is below a second signal strength threshold; and
based on the signal strength metric not being below the second signal strength threshold, ignoring the second request.

14. The method of claim 1, wherein:
the wireless communication link comprises a Bluetooth® link, and
the configuration profile comprises a Bluetooth® profile.

15. The method of claim 14, wherein the Bluetooth® profile comprises an Advanced Audio Distribution Profile (A2DP), a Hands-Free, or an Object Push Profile (OPP) profile.

16. The method of claim 1, wherein the signal strength metric comprises a received signal strength indication (RSSI).

17. The method of claim 1, wherein the reliability metric comprises a non-acknowledge rate.

18. A controller wireless device, comprising:
a memory;
a wireless interface; and
at least one processor communicatively coupled to the memory and the wireless interface, the at least one processor configured to:
establish a wireless communication link with a remote wireless device according to a configuration profile for a wireless communications standard;
receive, from the remote wireless device, a first request to increase a transmit power level of the controller wireless device;
determine whether a signal strength metric for the wireless communication link is below a first signal strength threshold, whether a reliability metric for the wireless communication link is below a first reliability threshold, or both; and
increase the transmit power level of the controller wireless device based on the signal strength metric being below the first signal strength threshold, the reliability metric being below the first reliability threshold, or both.

19. The controller wireless device of claim 18, wherein the at least one processor being configured to determine comprises the at least one processor being configured to:
determine whether the signal strength metric is below the first signal strength threshold, whether the reliability metric is below the first reliability threshold, or both based on a current transmit power level of the controller wireless device being greater than or equal to a power level threshold.

20. The controller wireless device of claim 19, wherein, based on the current transmit power level of the controller wireless device being below the threshold, the wireless controller device increases the transmit power level of the controller wireless as requested by the remote wireless device.

21. The controller wireless device of claim 19, wherein the power level threshold comprises a power level at which only an internal power amplifier (iPA) is used for transmitting over the wireless communication link.

22. The controller wireless device of claim 19, wherein the power level threshold comprises a power level at which an external power amplifier (xPA) is used for transmitting over the wireless communication link.

23. The controller wireless device of claim 18, wherein the at least one processor is further configured to:
determine whether the signal strength metric is above a second signal strength threshold, whether the reliability metric is above a second reliability threshold, or both; and
decrease, based on the signal strength metric being above the second signal strength threshold, the reliability metric being above the second reliability threshold, or both, the transmit power level of the controller wireless device.

24. The controller wireless device of claim 23, wherein the at least one processor being configured to decrease comprises the at least one processor being configured to:
decrease the transmit power level of the controller wireless device one transmit power level.

25. The controller wireless device of claim 23, wherein the at least one processor periodically determines whether the signal strength metric is above the second signal strength threshold, whether the reliability metric is above the second reliability threshold, or both.

26. The controller wireless device of claim 23, wherein:
the second signal strength threshold is higher than the first signal strength threshold, and
the second reliability threshold is higher than the first reliability threshold.

27. The controller wireless device of claim 18, wherein the at least one processor being configured to increase comprises the at least one processor being configured to:
increase the transmit power level of the controller wireless device one transmit power level.

28. The controller wireless device of claim 18, wherein the at least one processor is further configured to:
receive, from the remote wireless device, a second request to increase the transmit power level of the controller wireless device;
determine whether the signal strength metric is below a second signal strength threshold and whether the reliability metric is below the first reliability threshold; and
increase, based on the signal strength metric being below the second signal strength threshold and the reliability metric being below the first reliability threshold, the transmit power level of the controller wireless device.

29. The controller wireless device of claim 28, wherein the second signal strength threshold is lower than the first signal strength threshold.

30. The controller wireless device of claim 18, wherein the at least one processor is further configured to:
receive, from the remote wireless device, a second request to increase the transmit power level of the controller wireless device;
determine whether the signal strength metric is below a second signal strength threshold; and
ignore the second request based on the signal strength metric not being below the second signal strength threshold.

31. The controller wireless device of claim 18, wherein:
the wireless communication link comprises a Bluetooth® link,
the configuration profile comprises a Bluetooth® profile, and
the Bluetooth® profile comprises an Advanced Audio Distribution Profile (A2DP), a Hands-Free, or an Object Push Profile (OPP) profile.

32. The controller wireless device of claim 18, wherein the signal strength metric comprises a received signal strength indication (RSSI).

33. The controller wireless device of claim 18, wherein the reliability metric comprises a non-acknowledge rate.

34. A controller wireless device, comprising:
means for establishing a wireless communication link with a remote wireless device according to a configuration profile for a wireless communications standard;
means for receiving, from the remote wireless device, a first request to increase a transmit power level of the controller wireless device;
means for determining whether a signal strength metric for the wireless communication link is below a first signal strength threshold, whether a reliability metric for the wireless communication link is below a first reliability threshold, or both; and
means for increasing the transmit power level of the controller wireless device based on the signal strength metric being below the first signal strength threshold, the reliability metric being below the first reliability threshold, or both.

35. A non-transitory computer-readable medium storing computer-executable instructions, the computer-executable instructions comprising:
at least one instruction instructing a controller wireless device to establish a wireless communication link with a remote wireless device according to a configuration profile for a wireless communications standard;
at least one instruction instructing the controller wireless device to receive, from the remote wireless device, a first request to increase a transmit power level of the controller wireless device;
at least one instruction instructing the controller wireless device to determine whether a signal strength metric for the wireless communication link is below a first signal strength threshold, whether a reliability metric for the wireless communication link is below a first reliability threshold, or both; and
at least one instruction instructing the controller wireless device to increase the transmit power level of the controller wireless device based on the signal strength metric being below the first signal strength threshold, the reliability metric being below the first reliability threshold, or both.
